(19) United States
(12) Patent Application Publication
(10) Pub. No.: US 2007/0068302 A1
(43) Pub. Date: Mar. 29, 2007

(54) Hydraulic active damping system for gears and method

(76) Inventors: Michael Francis O'Leary, Howell, MI (US); David A. Gilbert, Royal Oak, MI (US); Jeffrey S. Rayce, Royal Oak, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/209,605

(22) Filed: Aug. 23, 2005

(51) Int. Cl. F16H 55/14

(52) U.S. Cl. 74/443; 74/409

(57) ABSTRACT

The present invention provides a hydraulic active damping system to damp gears, thereby reducing the occurrence of gear rattle or noise. The active nature of the present invention will allow the drag within the bearing to which the gear mounts to be selectively increased, by pressurizing an enclosed or specialized bearing with fluid during critical events. The pressure within the specialized bearing is subsequently decreased, thereby only increasing the system drag at critical operating conditions. The present invention also provides a method of damping gears by introducing pressurized fluid into a specialized bearing and subsequently reducing the fluid pressure therein.

### TECHNICAL FIELD

The present invention relates to active gear damping mechanisms.

### BACKGROUND OF THE INVENTION

Intermeshing gears may sometimes produce a noise or gear rattle during transient relative rotational speed changes between a drive and a driven gear. One example where this may occur is within a manual shift or countershaft transmission. A countershaft transmission has an input shaft, a countershaft, and an output shaft. The input shaft and the countershaft are interconnected by meshing gears (head gear set). The countershaft and the output shaft are interconnected by a plurality of meshing gears (speed gears) that are selectively connectible to one of the shafts through synchronizer clutch arrangements. Thus, a plurality of gear meshes are present between the input shaft and the output shaft. The speed ratio between the input shaft and the output shaft is controlled by the meshing speed gears. The speed ratio between the input shaft and the output shaft is changed by interchanging the synchronizers that control the connection of the speed gears to their respective shafts. The head gear set and the active speed gear set have a lash condition. Under some operating conditions, the lash condition of the head gear set and the active speed gear set can reverse resulting in a gear rattle caused by the lash reversal.

Gear rattle may occur as a transient lash condition during transient drive events such as throttle “tip in”, throttle “tip out”, and rapid clutch disengagement. As is well known, the clutch is disengaged and re-engaged for each ratio interchange and during stopping and launching of the vehicle. Additionally, a countershaft transmission may exhibit gear rattle under steady state drive events, such as when the vehicle is traversing a hill in gear. The gear rattle, in this case, is caused by engine generated torque oscillations within the driveline.

Modern vehicular drivelines may have a number of additional components that may also include meshing gear sets that may be subject to gear rattle. These may include transaxles, transfer cases, and differentials.

Attempts have been made to attenuate gear rattle. These include various bearing designs, component designs, and gear designs to name a few. Each of these attempts may result in increased drag on the shafts to which the gear is mounted, which may be continuously present. This inherent drag may reduce the mechanical efficiency of the system.

### SUMMARY OF THE INVENTION

The present invention provides a system and method to actively damp gears thereby reducing the occurrence of gear rattle as a transient lash condition. The active nature of the present invention will allow the drag within the bearing to which the gear mounts to be selectively increased, thereby only increasing the system drag at critical operating conditions. The ability to selectively increase drag may translate into increased mechanical system efficiencies, fuel economy, and component life over traditional means of gear rattle attenuation.

Accordingly, the present invention provides a hydraulic active damping system having a drive gear and a driven gear in meshing relation with the drive gear. The driven gear and the drive gear have a transient lash condition. A fluid supply structure is also provided. At least one of the drive gear and the driven gear is mounted on an enclosed bearing, where the enclosed bearing is selectively pressurizable by the fluid supply structure to vary frictional loss within the enclosed bearing in response to whether the transient lash condition is present or absent.

The present invention may include a hydraulic pump operable to selectively deliver pressurized fluid to the enclosed bearing via the supply structure. An electric motor may be provided to drive the hydraulic pump. The electric motor may receive control signals from an electronic control unit. The present invention may also provide a fluid return structure operable to evacuate air and/or fluid from the enclosed bearing. Additionally, the hydraulic active damping system of the present invention may include a flow restrictor in one or both of the fluid supply structure and the fluid return structure. The flow restrictors are operable to provide fluid flow control within the structures.

The present invention also provides a method of actively damping at least one gear subject to a transient lash condition by mounting the gear on an enclosed bearing capable of being selectively pressurized with fluid. Then, the enclosed bearing is pressurized with fluid to increase frictional loss within the enclosed bearing when transient lash condition is present. Subsequently, the enclosed bearing is de-pressurized when the transient lash condition is absent

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic diagram of the hydraulic active damping system of the present invention illustrating the various elements of the system;

FIG. 2 is a fragmentary sectional schematic view of a powertrain illustrating an exemplary embodiment of the present invention;

FIG. 3 is a diagrammatic representation of gears within the countershaft transmission illustrating gear tooth mesh; and

FIG. 4 is a sectional perspective view of a portion of the powertrain shown in FIG. 2 illustrating the incorporation of the present invention within a countershaft transmission.

### DESCRIPTION OF THE PREFERRED EMBODIMENTS

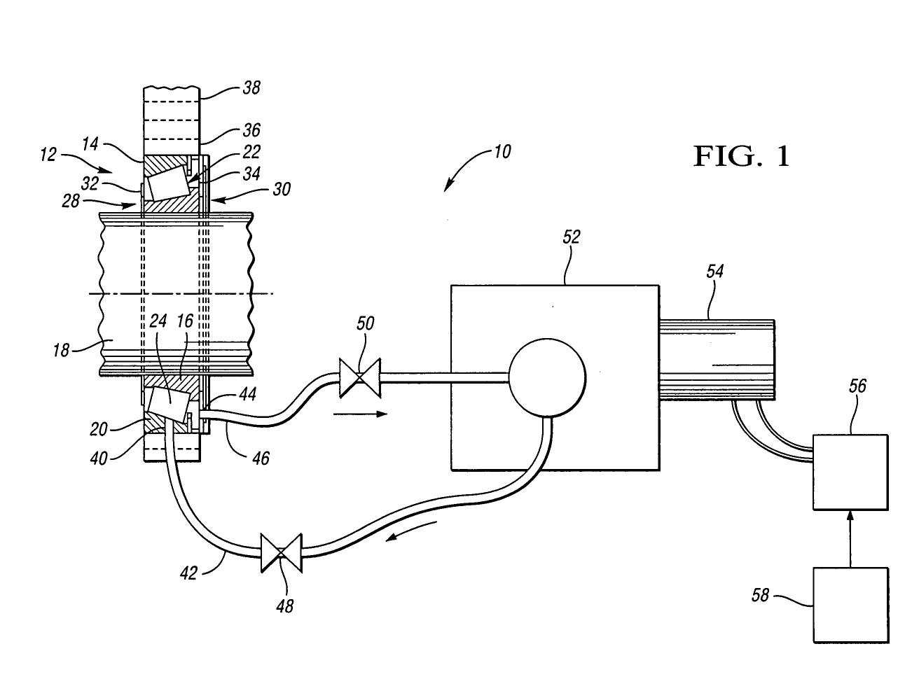

FIG. 1 is an exemplary schematic diagram of a hydraulic active damping system 10 of the present invention. The hydraulic device 12 is a sealed or enclosed specialized roller bearing 14 having an inner race 16 axially disposed about a shaft 18. Circumscribing the inner race 16 is an outer race 20. A void or enclosure 22 is defined by both the inner race 16 and the outer race 20 and a plurality of roller elements 24 disposed therein. The first axial side 28 and the second axial side 30 of the specialized roller bearing 14 are sealed by a first seal 32 and second seal 34. Mounted with respect to the outer race 20 is a gear 36 that may be in meshing contact with a gear 38.

The hydraulic device 12 further includes a fluid supply port 40 operable to form a passage through which pressurized fluid may flow from the fluid supply structure 42 into the volume of void 22 not occupied by the plurality of roller elements 24. The location of the fluid supply port 40 will be dictated by the component design and may be located within the inner race 16, first seal 32, second seal 34, or outer race 20, as shown. The fluid supply structure 42 may include cast in place or drilled passages, or external lines.

Additionally, the hydraulic device 12 includes a fluid return port 44 operable to form a passage through which pressurized fluid may flow from the volume of void or enclosure 22 not occupied by the plurality of roller elements 24 to the fluid return structure 46. The location of the fluid return port 44 will be dictated by the component design and may be located in the inner race 16, first seal 32, outer race 20, or second seal 34, as shown. The fluid return structure 46 may be cast in place, drilled passages, or external lines. The fluid return port 44 and fluid return structure 46 cooperate to evacuate air and/or fluid that may be trapped within the enclosed or specialized roller bearing 14 thereby enabling complete filling upon pressurization of the hydraulic device 12. Additionally the fluid return port 44 will provide an opening through which fluid may be scavenged from the bearing upon activation of the hydraulic active damping system 10.

A supply flow restrictor 48 and return flow restrictor 50 cooperate to control the fluid flow and pressure within the hydraulic device 12. The supply flow restrictor 48 and return flow restrictor 50 may be a type of valve known in the art of hydraulic controls or may simply be an appropriately sized orifice.

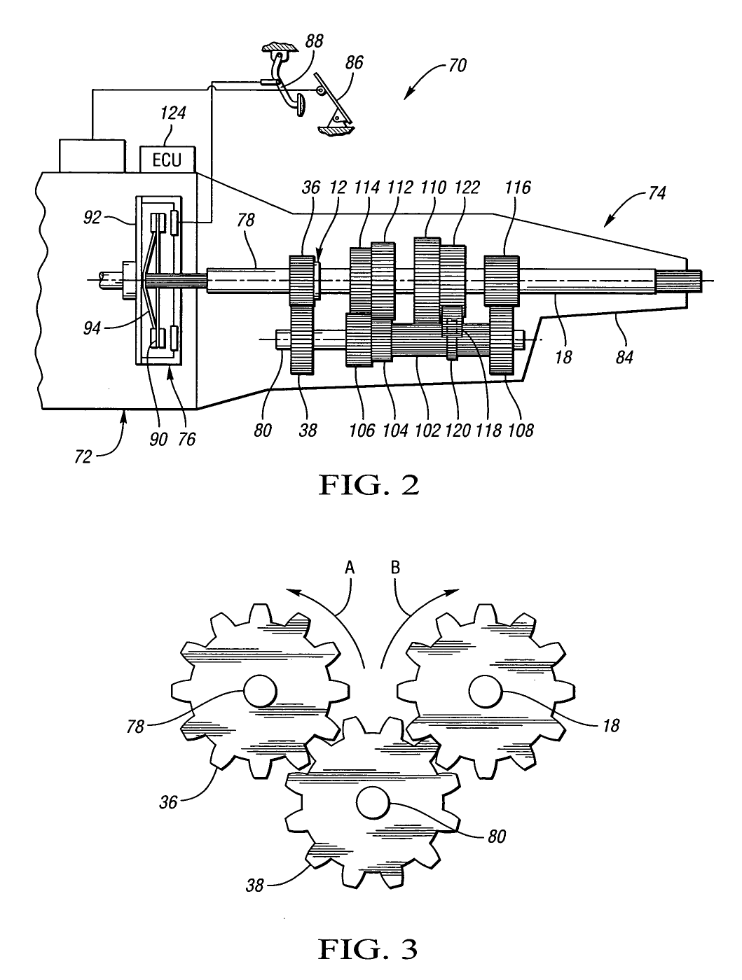

Fluid within the fluid return structure 46 feeds the suction side of a hydraulic pump 52. The pressure side of the hydraulic pump 52 feeds pressurized fluid to the fluid supply structure 42. The hydraulic pump 52 is operated by an electrical motor 54, which is in electrical communication with the electronic control module 56. The electronic control module 56 is operable to start and stop the electric motor 54 thereby providing pressurized fluid to the fluid supply structure 42. Various inputs 58 are input to the electronic control module 56, and may include vehicle operating conditions such as engine speed, vehicle speed, etc. The electronic control module may be included in the electronic control unit 124, shown in FIG. 2, or may be separate.

A tapered roller bearing 14 is shown in FIG. 1; however, those skilled in the art will comprehend that other types of bearings such as ball, straight roller, and needle may be used within the enclosure 22 of the hydraulic device 12 while remaining within the scope of that which is claimed.

FIG. 2 is a fragmentary sectional schematic view of a powertrain 70 illustrating an exemplary embodiment of the present invention. A powertrain 70 has an engine 72 and a countershaft transmission 74. The countershaft transmission 74 includes a manually actuated clutch assembly 76, an input shaft 78, a countershaft 80, and an output shaft 18 disposed within a housing 84. The input shaft 78 is coaxially aligned with the output shaft 18 and the countershaft 80 is rotatably supported within the housing 84 in a parallel relation with both the input shaft 78 and the output shaft 18.

The engine 72 has a throttle control 86 and the clutch assembly 76 has a clutch control 88. Both of the controls 86 and 88 are manually operated by the operator. The clutch assembly 76 includes a friction element 90 that is urged into and out of engagement with an engine flywheel 92 by actuation of the clutch control 88 and a diaphragm spring 94. Upon engagement of the clutch 76, the engine 72 will couple with the input shaft 78 and rotate with a common rotational speed.

The input shaft has a head gear 36 drivingly connected thereto and meshing with a head gear 38 that is drivingly connected with the countershaft 80 such that the countershaft 80 will rotate whenever the input shaft 78 is rotating. The countershaft 80 has a plurality of speed or ratio gears 102, 104, 106, and 108 drivingly connected therewith and meshing with respective speed or ratio gears 110, 112, 114 and 116 that are disposed on the output shaft 18. A reverse idler 118 is rotatably mounted on an idler shaft, not shown, and is in meshing relation with a ratio gear 120 on countershaft 80 and a ratio gear 122 on output shaft 18. Each of the ratio gears 110, 112, 114, 116, and 122 are selectively, individually connectable with the output shaft 18 by respective synchronizers, not shown, of conventional design. A hydraulic device 12 that may be selectively pressurized with fluid is positioned between the head gear 36 and the output shaft 18.

When the operator wishes to change the speed ratio between the input shaft 78 and the output shaft 18, the throttle control 86 is released and clutch mechanism is 88 is actuated by the operator. The operator then manually, through a conventional shift control linkage not shown, manipulates the synchronizers to release one gear set and engage another. This operation is well known in the art. In addition, during vehicle deceleration, the operator releases the throttle control 86 to permit a reduction in engine speed thereby slowing the vehicle. This throttle release is also known as “tip out”.

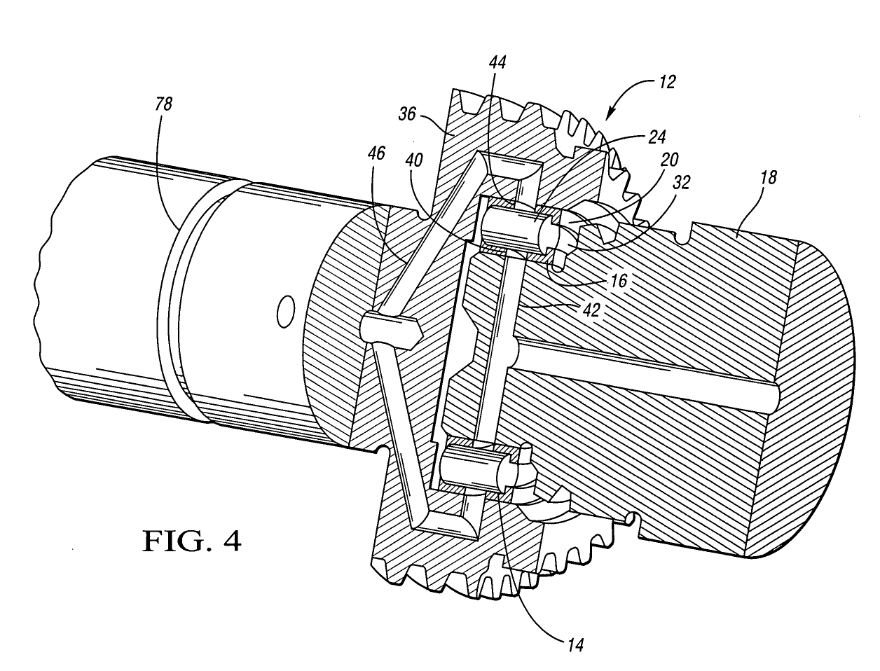

The hydraulic device 12 is operable to increase the frictional drag between the input shaft 78 and the output shaft 18 when the hydraulic device 12 is pressurized. The output shaft 18 is rotatably supported on the input shaft 78 by the specialized or enclosed roller bearing 14, shown in FIG. 4, of the hydraulic device 12. Upon pressurization of the hydraulic device 12, changes in relative motion between the input shaft 78, the countershaft 80, and the output shaft 18 are restrained due to the frictional drag caused by the attritional volume of pressurized fluid within-the hydraulic device 12. Therefore, the drag torque and direction remain essentially unchanged such that the tooth contact between the torque carrying gear members is undisturbed. In other words, the gears on the input shaft 78, the countershaft 80, and the output shaft 18 are constrained from moving into their lash zones. The frictional drag within the hydraulic device 12 may be controlled such that the drag occurs only when significant changes in gear lash might be present. Therefore, the efficiency of the powertrain is not significantly affected.

Significant changes in the gear lash can occur during various operating conditions. If the clutch is rapidly disengaged, the torque carrying ratio gear set and the head gear set change from a forward driven mesh to a reverse driven mesh. This results in noise or rattle in the clutch, the splines, and the gear meshes. Another situation wherein the gear lash might change is upon a sudden actuation or release of the throttle, which results in a rapid change in engine speed and therefore the speed of the input shaft 78. Additionally, a countershaft transmission 74 may exhibit gear rattle under steady state drive events, such as when the vehicle is traversing a hill in gear. The gear rattle, in this case, is caused by engine generated torque oscillations within the driveline. The pressurization of the hydraulic device 12 under this operating condition may also prevent gear noise, due to gear lash changes. In each of these and many other operating conditions, the electronic control unit 124 may anticipate the gear lash change, and selectively pressurize the hydraulic device 12 to prevent the noise that might otherwise occur. In each of the operating conditions that result in gear rattle or clutch clunk, the input shaft 78 undergoes a rapid acceleration. The control scheme may be programmed to ignore acceleration levels that occur within the normal operating range of the powertrain 70.

FIG. 3 is a representation of the meshing relation between the head gear 36 on the input shaft 78, the head gear 38 on the countershaft 80, and the ratio gears on the countershaft 80 and the output shaft 18. The ratio gears shown in FIG. 3 are only representative of the ratio gears shown in FIG. 2, and the output shaft 18 is shown rotated out of alignment with the input shaft 78 for clarity. The arrows A and B represent the direction of drag torque imposed by the hydraulic device 12 when pressurized.

FIG. 4 is a sectional perspective view of a portion of the powertrain 70 shown in FIG. 2 illustrating the incorporation of the hydraulic device 12 within the countershaft transmission 74. As mentioned above, the output shaft 18 is rotatably supported on the input shaft 78 by the enclosed or specialized roller bearing 14 of the hydraulic device 12. The enclosed or specialized roller bearing 14 has an inner race 16 and an outer race 20 with a plurality of roller elements 24 disposed therebetween. The axial ends of the specialized bearing 14 are sealed with a first seal 32 and a second seal, not shown. When additional damping of the head gear 36 is required, pressurized fluid will move through a fluid supply structure 42 to a fluid supply port 40 defined within the inner race 16. The pressurized fluid will increase frictional losses within the specialized bearing 14. Simultaneously any air and/or fluid within the enclosed or specialized bearing 14 will pass through the fluid return port 44 defined by the outer race 20 and into the fluid return structure 46.

When damping of the head gear 36 is no longer required, the pressurized fluid flow within the fluid supply structure 42 will be discontinued. The fluid remaining within the enclosed or specialized bearing 14 will be scavenged by a hydraulic pump, by introducing suction to the enclosed or specialized bearing 14 through the fluid return structure 46 and the fluid return port 44.

While the best modes for carrying out the invention have been described in detail, those familiar with the art to which this invention relates will recognize various alternative designs and embodiments for practicing the invention within the scope of the appended claims.

1. A hydraulic active damping system comprising:
a drive gear;
a driven gear in meshing relation with said drive gear, wherein said driven gear and said drive gear are subject to a transient lash condition;
a fluid supply structure; and
at least one of said drive gear and said driven gear being mounted on an enclosed bearing, said enclosed bearing being selectively pressurizable by said fluid supply structure to vary frictional loss within said enclosed bearing in response to whether said transient lash condition is present or absent.

2. The hydraulic active damping system of claim 1, further comprising:
a hydraulic pump operable to selectively deliver pressurized fluid to said enclosed bearing via said fluid supply structure.

3. The hydraulic active damping system of claim 2, further comprising:
an electric motor operable to drive said hydraulic pump.

4. The hydraulic active damping system of claim 3, further comprising:
an electronic control module operable to control said electric motor.

5. The hydraulic active damping system of claim 1, further comprising:
fluid return structure operable to evacuate air and/or fluid from said enclosed bearing.

6. The hydraulic active damping system of claim 1, wherein said fluid supply structure includes a supply flow restrictor operable to provide fluid flow control within said fluid supply structure.

7. The hydraulic active damping system of claim 5, wherein said fluid return structure includes a return flow restrictor operable to provide fluid flow control within said fluid return structure.

8. The hydraulic active damping system of claim 1, wherein said enclosed bearing is a roller bearing.

9. The hydraulic active damping system of claim 1, wherein said enclosed bearing is a ball bearing.

10. A method of actively damping at least one gear subject to a transient lash condition, comprising:
mounting said at least one gear on an enclosed bearing capable of being selectively pressurized with fluid;
pressurizing said enclosed bearing with fluid to increase frictional loss within said enclosed bearing when a transient lash condition is present; and
subsequently de-pressurizing said enclosed bearing when the transient lash condition is absent.

11. A hydraulic active damping system comprising:
a drive gear;
a driven gear in meshing relation with said drive gear, wherein said driven gear and said drive gear are subject to a transient lash condition;
a fluid supply structure;
a supply flow restrictor operable to provide fluid flow control within said fluid supply structure;
a hydraulic pump operable to selectively deliver pressurized fluid to said enclosed bearing via said fluid supply structure;
at least one of said drive gear and said driven gear being mounted on an enclosed bearing, said enclosed bearing being selectively pressurizable by said fluid supply structure to vary frictional loss within said enclosed bearing in response to whether said transient lash condition is present or absent;
a fluid return structure operable to evacuate air and/or fluid from said enclosed bearing; and
a return flow restrictor operable to provide fluid flow control within said fluid return structure.

12. The hydraulic active damping system of claim 11, further comprising:
an electric motor operable to drive said hydraulic pump.

13. The hydraulic active damping system of claim 12, further comprising:
an electronic control module operable to control said electric motor.

14. The hydraulic active damping system of claim 11, wherein said enclosed bearing is a roller bearing.

15. The hydraulic active damping system of claim 11, wherein said enclosed bearing is a ball bearing.
